(19) United States
(12) Patent Application Publication
(10) Pub. No.: US 2006/0125283 A1
(43) Pub. Date: Jun. 15, 2006

(54) Drive arrangement for activating the hatch of a motor vehicle

(75) Inventor: Mehmet Guler, Recklinghausen (DE)

Correspondence Address: ROBERTS, MLOTKOWSKI & HOBBES, P. O. BOX 10064, MCLEAN, VA, 22102-8064, US

(73) Assignee: Brose Schliesssysteme GmbH & Co. KG, Wuppertal (DE)

(21) Appl. No.: 11/265,502

(22) Filed: Nov. 3, 2005

(30) Foreign Application Priority Data
Nov. 3, 2004 (DE) 20 2004 017 178.3

(51) Int. Cl. B60J 5/10

(52) U.S. Cl. 296/146.4

(57) ABSTRACT

A drive arrangement for actuating a hatch of a motor vehicle with a drive for producing driving having a drive motor for producing movement of the hatch between an open position and a closed position and having a transmission linkage connected on the output side of the motor. The transmission linkage has a first driven lever and a second driven lever for transmission of pushing forces and/or pulling forces to the hatch, and the driven levers, in the installed state, converge on a joint arrangement which is located on the hatch and are coupled to it by drive engineering in a manner such that the lines of dynamic effect of the two driven levers form an included angle with one another which corresponds to the respective position of the hatch.

### BACKGROUND OF THE INVENTION

1. Field of Invention

This invention relates to a drive arrangement for actuating the hatch of a motor vehicle with a drive, the hatch being coupled to the body to pivot around a hatch axis, and in this way, the hatch opening of the body can be closed. The drive for producing the drive motions has a drive motor and transmission linkage connected on the output side, and movement of the hatch between an open position and a closed position can be effected with a drive motion. The invention also relates to a hatch arrangement, especially a rear hatch arrangement of a motor vehicle with the aforementioned drive arrangement.

2. Description of Related Art

The term “hatch” of a motor vehicle is to be understood comprehensively here. Accordingly, it includes not only the rear hatch, the trunk lid, the hood or the cargo space hatch of a motor vehicle but, for example, also the side doors or a lifting sunroof of a motor vehicle, if present. The hatch under consideration is coupled to the body of the motor vehicle to be able to pivot around a pivot axis, by which the hatch opening of the body can be closed.

It should be pointed out that the aforementioned body of the motor vehicle in this description does not include the hatch. The hatch of the motor vehicle is, therefore, not a component of the body of the motor vehicle here.

Motorized actuation of hatches of a motor vehicle, therefore the motorized opening motion and closing motion, are becoming increasingly important at present for enhancing the ease of operation of a motor vehicle.

The known drive arrangement for motorized actuation of the hatch of a motor vehicle underlying the invention for producing the drive motions necessary for actuating the hatch, hereinafter called the actuating motions, has a drive motor with a transmission linkage which is connected on the output side and which is made as spindle transmission linkage with a spindle and spindle nut. The spindle nut is coupled by drive engineering to the hatch by way of a reversing lever. Such a drive arrangement is shown in German Patent Application DE 101 17 935 A1 and corresponding U.S. Patent Application Publication 2004/0090083 A1. The advantage here is that the driving force acting on the hatch from the drive arrangement has only a small component or none at all in the direction of the hatch axis. This component of the driving force basically leads specifically to undesirable loading of the components involved. In any case, the use of a spindle-nut transmission is associated with high implementation costs, poor durability and especially high wear. Furthermore, the actuating speed can only be increased to a limited degree. The efficiency of the drive arrangement is thus altogether limited.

### SUMMARY OF THE INVENTION

A primary object of the invention is to embody and develop the known drive arrangement such that its efficiency is increased without necessarily having to tolerate an axial dynamic effect of the drive arrangement on the hatch. Here, “axial dynamic effect” means the action of a force in the direction of the hatch axis.

The aforementioned object is achieved by a drive arrangement in which the transmission linkage has a first driven lever and a second driven lever for transmission of pushing forces and/or pulling forces to the hatch, the driven levers, in the installed state, converging on a joint arrangement which is located on the hatch and are coupled to it by drive engineering, and in which the lines of dynamic effect of the two driven levers include with one another an angle which corresponds to the respective position of the hatch, i.e., the driven angle.

Here, the finding is important that, with a corresponding arrangement of the driven lever, the axial dynamic effect of one driven lever against the axial dynamic effect of the other driven lever can be cancelled. The actuating motions of the two driven levers can be easily controlled so that an efficient and simultaneously durable drive arrangement can be implemented.

The two driven levers are used to transmit pushing forces and/or pulling forces on the hatch, the lines of dynamic effect of the two driven levers forming an included angle with one another which corresponds to the respective position of the hatch. This angle is called the driven angle below. In preferred configurations, the angle bisector of the driven angle lies essentially in a vertically aligned plane which intersects the central lengthwise axis of the motor vehicle. Furthermore, the driving force acting on the hatch from the drive arrangement does not have any component in the direction of the hatch axis. As a result, complete elimination of the axial dynamic effect of the drive arrangement on the hatch is ensured.

In further preferred configuration, the two drive levers are combined with the driven levers in the manner of scissors kinematics. With it, any transmission ratios of the transmission linkage can be easily achieved for the most part.

An especially durable and at the same time compact configuration implements the drive-engineering coupling between the drive motor and the transmission linkage in an especially simple manner by the ends of the drive levers, which ends are facing away from the respective driven levers, each being equipped with an arc-shaped toothed segment which is aligned around the pivot axis of the drive levers. One toothed segment has an external tooth system and the other toothed segment has an internal tooth system which faces this external tooth system, the drive motor having a rotatable driving pinion that engages the two toothed segments by drive engineering.

A further preferred configuration of the drive arrangement with a linear drive, depending on the application, can lead to optimum use of installation space and to optimum transmission behavior of the transmission linkage. By having the ends of the drive levers which face away from the respective driven levers coupled to the linear drive by drive engineering, the transmission linkage can be easily designed such that both the stress of spindle-nut transmission and the associated wear are low. The two connecting joints between the drive lever and the driven lever are guided here on a corresponding guide rail.

Another possibility of the configuration of the transmission linkage has the second drive lever eccentrically coupled to the first drive lever with respect to the pivot axis of the first drive lever and the second connecting joint guided between the second drive lever and the second driven lever in an arc-shaped guide rail. The extension of the guide rail is especially small due this special configuration.

Numerous possibilities are conceivable for the configuration of the joint arrangement and the connecting joints. Universal joints are possible here in an especially preferred configuration.

However, it can also be provided that joints with two joint axes aligned perpendicular to one another are used here, the two joint axes of the connecting joints being spaced apart from one another. In any case, then, it can be ensured, optionally by an additional ball joint or the like, that sufficient degrees of freedom of motion are guaranteed.

Altogether, it is such that the design freedom which prevails here in the design of the coupling from the drive levers by way of the driven levers to the hatch enables optimum adaptation to the respective installation space conditions. For example, it can be achieved by a suitable design that a reversing lever which is conventionally provided on the hatch can be completely abandoned.

The invention is explained in detail below with reference to the embodiments shown in the accompanying drawings.

### BRIEF DESCRIPTION OF THE DRAWINGS

FIG. 1 shows a side view of the rear of a motor vehicle with the hatch closed with a drive arrangement in accordance with the invention, an encircled detail being shown separately in addition.

FIG. 2 is a perspective view of the drive arrangement shown in FIG. 1 in the dismounted state,

FIG. 3 is a plan view of a second drive arrangement in accordance with the invention in the dismounted state,

FIG. 4 is a plan view of a third drive arrangement according to the invention in the dismounted state.

### DETAILED DESCRIPTION OF THE INVENTION

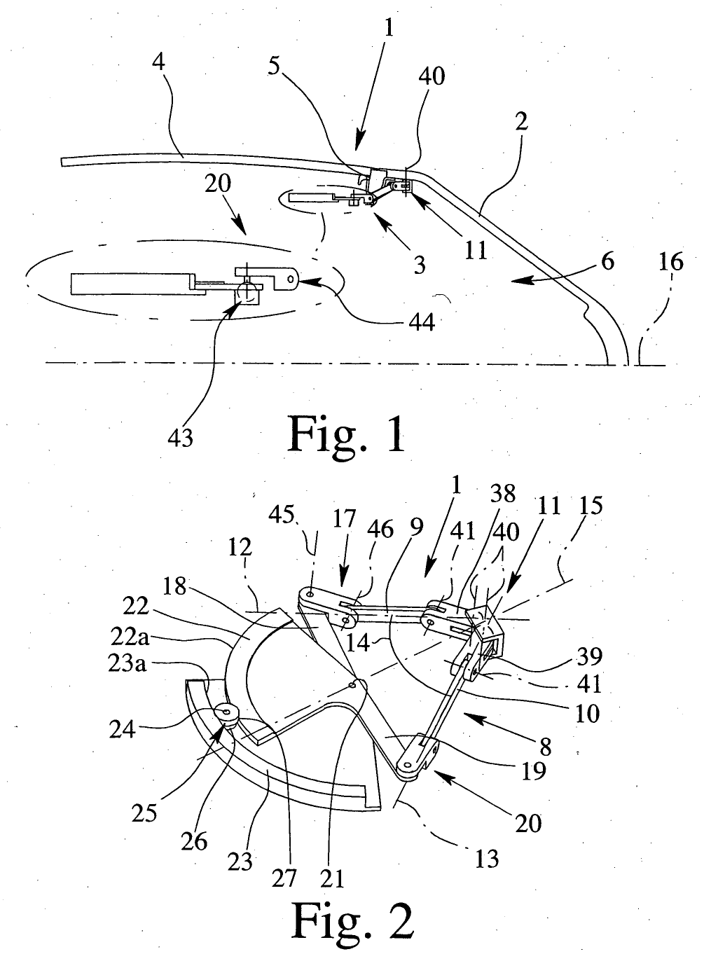

The drive arrangement 1 shown in FIG. 1 is in the installed state. It is used to actuate the hatch 2 of the illustrated motor vehicle and has a drive 3 for this purpose. Basically, it can also be provided that there are several drives 3, preferably two drives 3, each preferably laterally arranged, for actuating the hatch 2.

The hatch 2 is coupled to the body 4 of the motor vehicle to pivot around the hatch axis 5, by which the hatch opening 6 of the body 4 can be closed. It should be pointed out that, as described above, the term “hatch” should be understood comprehensively here. Especially with respect to optimum use of installation space, the drive arrangement 1 of the invention, however, can be applied especially advantageously to the rear hatch or the trunk lid of a motor vehicle.

To produce driving motions, the drive 3 is equipped with a drive motor 7 and a transmission linkage 8 connected on the output side of the drive motor 7. Movement of the hatch 2 between the open position (not shown) and a closed position (FIG. 1) can be caused by the corresponding drive motion. This drive motion is called an “actuating motion” below.

The transmission linkage 8 has a first driven lever 9 and a second driven lever 10 for transmission of pushing forces and/or pulling forces to the hatch 2. In the embodiment shown in FIG. 1 and which is preferred in this respect, exclusively pushing forces are transmitted by way of the driven levers 9, 10. The driven levers 9, 10, in the installed state, converge on a joint arrangement 11 which is located on the hatch 2 and are coupled to it by drive engineering. The lines of dynamic effect 12, 13 of the two driven levers 9, 10 define an included angle relative to one another which corresponds to the respective position of the hatch 2, which angle is called the driven angle 14 below.

FIG. 2 shows the drive arrangement 1 in the dismounted state when the hatch is in the closed position. It can be taken from FIGS. 1 & 2 that movement of the hatch 2 from the closed position into the open position causes the driven angle to be reduced.

In one especially preferred configuration, the angle bisector of the driven angle 14 lies essentially in a vertically aligned plane. Here “vertical alignment” means alignment perpendicular to the plane of the vehicle roof or the vehicle bottom. The drive 3 is preferably arranged such that this vertically aligned plane simultaneously intersects the lengthwise axis 16 of the motor vehicle. However, basically, it is also conceivable for the angle bisector of the driven angle 14 to be spaced apart from the lengthwise axis 16 of the motor vehicle. This is especially the case when there are two laterally arranged drives 3.

The arrangement is preferably made at this point such that the drive force acting on the hatch 2 from the drive arrangement 1 does not have any component in the direction of the hatch axis 5. In certain applications, it can also be advantageous if there is a certain dynamic effect in the axial direction, for example, in order to prevent play between the hatch 2 and the body 4. In the suggested approach, it is advantageous that this axial dynamic effect can be accurately predetermined by a corresponding design.

Quite especially, simple mechanical triggering of the driven levers 9, 10 is achieved by implementation of scissors kinematics. Here, the first driven lever 9 is pivotally coupled by way of a first connecting joint 17 to a first drive lever 18 and the second driven lever 10 is pivotally coupled to a second drive lever 19 by way of a second connecting joint 20. Here, “pivotally coupled” means coupling which allows pivoting in one or more degrees of freedom.

In the embodiment which is shown in FIG. 2 and which is preferred in this respect, it is provided that the two drive levers 18, 19 are coupled by drive engineering to the drive motor 7 which is shown in FIG. 2.

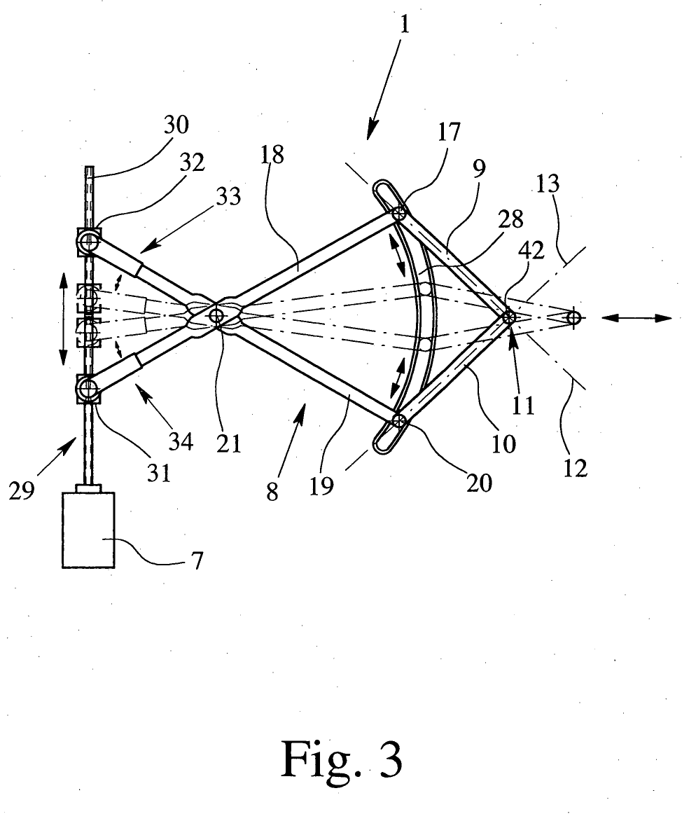

The basic structure of the drive arrangement 1 which is explained in conjunction with FIGS. 1 & 2 can also be found in the other preferred embodiments which are shown in FIGS. 3 & 4. In this respect, reference should be made to the aforementioned statements. Here, it is pointed out that, in the embodiments shown in FIGS. 3 & 4, only part of the joint arrangement 11 is illustrated.

It is common to all the illustrated embodiments that, in any case, the first drive lever 18 can be pivoted around a pivot axis 21 which is located between the two ends of the first drive lever 9. Here, the “ends” of the lever are the point or regions of the lever where the force is applied.

In the embodiments shown in FIGS. 2 & 3, the second drive lever 19 can also pivot around the pivot axis 21 which is arranged accordingly with respect to the two ends of the levers 18, 19, here the pivot axis 21 assigned to the drive lever 18 being identical to the pivot axis 21 assigned to the second drive lever 19. In the embodiments shown in FIGS. 2 & 4, the pivot axis 21 is stationary.

The embodiments shown in FIGS. 2 & 3 are made such that the two drive levers 18, 19 execute movements in opposite directions when the hatch 2 is actuated. The preferred angular range for the movements of the drive levers 18, 19 is roughly 70°.

The aforementioned motion of the two drive levers 18, 19 in opposite directions can be used for an especially compact coupling of the drive motor 7 to the transmission linkage 8. This is shown in FIG. 1. Here, the ends of the drive levers 18, 19, which ends are facing away from the respective driven levers 9, 10, are each equipped with an arc-shaped toothed segment 22, 23 which is aligned around the pivot axis 21 of the drive levers 18, 19. In the preferred configuration shown in FIG. 2, one toothed segment 22 has an external tooth system 22a and the other toothed segment 23 has an internal tooth system 23a which faces this external tooth system 22a. A driving pinion 25, which can turn around the axis of rotation 24 is assigned to the drive motor 7 which is not shown in this figure, apart from the driving pinion 25 of the drive motor 7 which drivingly engages the two toothed segments 22, 23.

In order to ensure that rotary motion of the driving pinion 25 in two drive levers 18, 19 causes drive motions which are quantitatively identical to one another, the driving pinion 25 is divided in two, viewed in the direction of its axis 24 of rotation. For the two toothed segments 22, 23, it has a pinion diameter which is different for each. Here, a pinion section 26 of smaller diameter is assigned to the toothed segment 22 which has the external tooth system 22a and a pinion section 27 of greater diameter is assigned to the toothed segment 23 which has the internal tooth system 22a.

For motorized actuation of the hatch 2 shown in FIG. 1, from the closed position into the open position, the driving pinion 25 in FIG. 2 can be actuated around to the right. In this way, the scissors formed by the drive levers 18, 19 and driven levers 9, 10 closes and the driving force transmitted by way of the driven levers 9, 10 accordingly causes the pivoting of the hatch 2. It becomes clear here that the transmission force of the transmission linkage 8 in the motorized movement of the hatch 2 into the open position continuously increases so that, to keep the hatch 2 in the open position, a comparatively small holding force can be applied by the drive motor 7 or by a brake which is optionally present.

The embodiment illustrated in FIG. 3 shows a preferred version for scissors kinematics. Here, it is provided that the two connecting joints 17, 20, between the first drive lever 18 and the first driven lever 9 and between the second drive lever 19 and the second driven lever 10 are guided in an arc-shaped guide rail 28 which is aligned around the pivot axis 21 of the drive levers 18, 19. When the hatch 2 is actuated, the pivot axis 21 moves to the left or right in FIG. 3.

In the embodiment shown in FIG. 3, there is special coupling of the drive motor 7 to the transmission linkage 8. The ends of the drive levers 18, 19 which face away from the respective driven levers 9, 10 are coupled here to the linear drive 29, specifically by drive engineering. The linear drive 29, preferably, has a drive worm 30 on which two drivers 31, 32 run. The drivers 31, 32 are coupled by drive engineering to a respective one of the drive levers 18, 19. For this purpose, there is a telescope-like coupling 33, 34 between the drivers 31, 32, and the respective drive lever 18, 19. The drive worm 30 is divided in two viewed along its axis of rotation, the two parts having worm threads which run opposite one another. This is necessary to be able to ensure the aforementioned opposing motion of the drive levers 18, 19. A more detailed configuration of the connecting joints 17, 20 and of the joint arrangement 11 is addressed below.

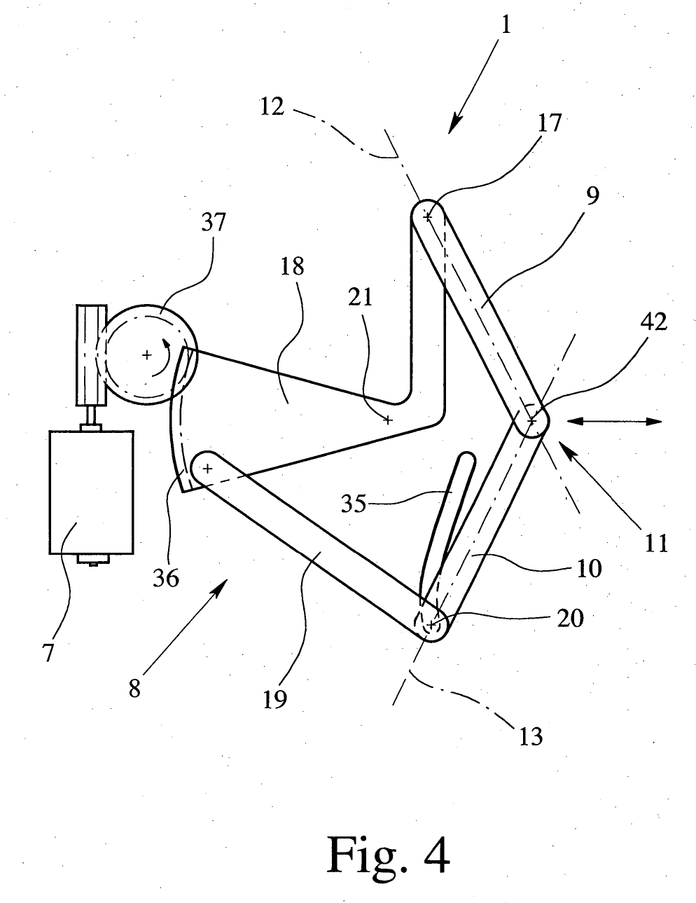

Another version of the preferred embodiment for the configuration of the drive arrangement 1 is shown in FIG. 4. Here, the second drive lever 19 is eccentrically coupled to the first drive lever 18 with respect to the pivot axis 21 of the first drive lever 18. Furthermore, the second connecting joint 20 is guided between the second drive lever 19 and the second driven lever 10 in an arc-shaped guide rail 25. In this arrangement, it is especially advantageous that the extension of the guide rail 25 with a corresponding design of the levers 9, 10, 18, 19 can be chosen to be accordingly small. In the preferred embodiment shown in FIG. 4, the end of the first drive lever 18 facing away from the first driven lever 9 is equipped with an arc-shaped toothed segment 36 which is aligned around the pivot axis 21 of the first drive lever 18. Accordingly, the drive motor 7 has a driving pinion 37 which engages the toothed segment 36 by drive engineering.

It can be summarized that, for all of the illustrated embodiments, the drive motions of the two drive levers 18, 19 cause motorized movement of the hatch 2 by way of the two driven levers 9, 10. Here, the drive motions of the drive levers 18, 19 proceed preferably parallel to a single plane. These motions are converted by way of the driven levers 9, 10 into a corresponding pivoting motion of the hatch 2. This imposes quite special requirements on the coupling from the drive levers 18, 19 by way of the driven levers 8, 10 to the hatch 2.

For coupling between the drive levers 18, 19 and the driven levers 9, 10, and furthermore, between the driven levers 9, 10 and the hatch 2, there are the aforementioned connecting joints 17, 20 and the joint arrangement 11. For the illustrated embodiments, a series of possibilities is possible for how the connecting joints 17, 20 and the joint arrangement 11 can be made. Some preferred versions are described below; they can be applied equally to all three illustrated embodiments.

In the embodiment shown in FIG. 2, the joint arrangement 11 has a first joint 38 for coupling to the first driven element 9 and a second joint 39 for coupling to the second driven element 10, the joints 38, 39 of the joint arrangement 11, preferably, having two degrees of freedom of motion. In this embodiment, the joints 38, 39 of the joint arrangement 11 each have a first joint axis 40 and a second joint axis 41 which are rigidly coupled to one another and are aligned perpendicular to one another. In one especially preferred configuration, these joints 38, 39 of the joint arrangement 11 are universal joints.

However, it can also be provided that the two joint axes 39, 40 of one joint 38, 39 of the joint arrangement 11 are spaced apart from one another. This is shown in FIG. 2. Then, a lengthwise axis which intersects the two joint axes 40, 41 at a vertical angle is assigned to the joint 38, 39. Pivoting of the hatch 2 around the hatch axis 5 here causes, among other things, pivoting of the joint 38, 39 around its lengthwise axis. In this way, an additional degree of freedom of motion in the coupling between the drive levers 18, 19 and the hatch 2 can be provided. One possibility for this is that the joints 38, 39 of the joint arrangement 11, at least in part, are made as a ball joint. The joints 38, 39 of the joint arrangement 11 can, however, also be made entirely as a ball joint. But, other types of joints can also be used if they provide the corresponding degrees of freedom of motion.

In the embodiment shown in FIG. 2, the first joint axis 40 of the two joints 38, 39 of the joint arrangement 11, in the installed state, is aligned essentially perpendicular to the hatch axis 5. Furthermore, the first joint axes 40, in the installed state, are preferably aligned parallel to one another.

The joint arrangement 11 can also be made such that at least one of its joints 38, 39 has joint axes aligned parallel to the hatch axis 5 in the mounted state. This is especially advantageous for the embodiments shown in FIGS. 3 & 4. Here, the ends of the driven levers 9, 10 which face away from the drive levers 18, 19 are coupled to one another by way of a joint axis 42 of a joint of the joint arrangement 11. Since, here, the connecting joints 17, 20 between the drive levers 18, 19 and the driven levers 9, 10 are single-axis pivot joints, the drive arrangement 1, at the joint axis 42, produces exclusively linear drive movements as would also be the case in a spindle drive (compare solid and dot-dash line positions in FIG. 3). Then, the joint arrangement 11 must be equipped with joints which have joint axes which are aligned parallel to the hatch axis 5. However, basically, it can also be provided that the joints 38, 39 of the joint arrangement 11 are combined at least partially into a single joint. This relates especially to the first joint axes 40 of the joints 38, 39.

The above considerations regarding the joints 38, 39 apply equally to the configuration of the connecting joints 17, 20 between the drive levers 18, 19 and the driven levers 9, 10. In particular, these connecting joints 17, 20, as shown in FIGS. 3 & 4, can be made as single-axis pivoting joints. However, otherwise, all the aforementioned types of joints can be used.

A preferred configuration of the connecting joints 17, 20 is shown in FIG. 1. Here, the connecting joint 17, 20, on the one hand, is made as a ball joint 43, and on the other hand, as a pivot joint 44. The pivot joint 44 here has two joint axes 45, 46 which are aligned perpendicular to one another, are rigidly coupled to one another, and are spaced apart from one another. In this respect, reference should be made to statements regarding the joints 38, 39 of the joint arrangement 11. Equipping the connecting joint 17, 20 with a ball joint 43 is therefore another possibility for how the above addressed additional degree of freedom of motion which is required by the pivoting motion of the hatch 2 can be implemented.

It is pointed out that the above described symmetrical structure especially with respect to the driven levers 9, 10, leads to an especially favorable application of force to the hatch 2, preferably without the resulting axial dynamic effect on the hatch 2. However, basically, it can also be provided that “half” of the scissors kinematics, as such, is omitted. This is then, to a certain extent, a “low-cost version”.

It is important to the flat construction of the drive arrangement 1 of the invention that the pivot axis 21 or the pivoting axes of the drive levers 18, 19 is or are aligned essentially perpendicular to the hatch axis 5. The minimum extension required for implementation of scissors kinematics is then aligned along a plane parallel to the hatch axis 5. This is especially advantageous since there is ordinarily enough installation space in the direction of this extension. One example of this is the area of the rear roof frame of the body 4.

Furthermore, it is pointed out that the joint arrangement 11, viewed in the transverse direction of the motor vehicle, is located preferably in the middle area of the vehicle and preferably near the hatch axis 5 in the installed state. This leads to a central application of force to the hatch 2; this, for example, prevents distortion of the hatch 2 during its motorized actuation.

Finally, it is noted that, in the drive arrangement 1 which is shown in FIG. 1, a reversing lever on the hatch 2 can be completely omitted. This is ensured by a special configuration of the joint arrangement 11 and of the connecting joints 17, 20. This special arrangement can, moreover, prevent the conventionally necessary transition of the driven levers 9, 10 from the dry space into the wet space of the body 4 and the hatch 2 with a corresponding duct. This is achieved by correspondingly lowered positioning of the drive motor 7 and of the drive levers 18, 19, as is likewise shown in FIG. 1.

Another teaching which acquires independent importance relates to a rear hatch arrangement of a motor vehicle which comprises everything which is necessary for achieving the above described advantages. They include, among others, the hatch 2, the part of the body 4 of the motor vehicle which contains the hatch opening 6, and the above described drive arrangements 1. Reference is made to the aforementioned statements.

What is claimed is:

1. Drive arrangement for actuating a hatch of a motor vehicle, the hatch being coupled to the body to pivot around a hatch axis for opening and closing a hatch opening of the body, the drive arrangement comprising:
a drive for producing drive motions having a drive motor and a transmission linkage connected on an output side of the drive motor for producing, in an installed state, movement of the hatch between an open position and a closed position,
wherein the transmission linkage has a first driven lever and a second driven lever for transmission of movement forces to the hatch, the driven levers converging on a joint arrangement which is located, in the installed state, on the hatch, the driven levers being coupled to the joint arrangement in a manner that lines of dynamic effect of the two driven levers form an included angle between them which, in the installed state, corresponds to the respective position of the hatch.

2. Drive arrangement as claimed in claim 1, wherein a angle bisector of said included angle lies essentially in a vertically aligned plane which intersects a central lengthwise axis of the motor vehicle in the installed state.

3. Drive arrangement as claimed in claim 1, wherein the movement forces acting on the hatch from the drive arrangement are perpendicular to the hatch axis.

4. Drive arrangement as claimed in claim 1, wherein the first driven lever is pivotally coupled by way of a first connecting joint to a first drive lever, wherein the second driven lever is pivotally coupled to a second drive lever by way of a second connecting joint, and wherein one of the two drive levers is coupled to the drive motor so as to be driven thereby.

5. Drive arrangement as claimed in claim 4, wherein the first drive lever is pivotable around a first lever pivot axis and wherein the first lever pivot axis of the first drive lever is located between opposite ends of the first drive lever.

6. Drive arrangement as claimed in claim 5, wherein the second drive lever is pivotable around a second lever pivot axis and wherein the second lever pivot axis is located between opposite ends of the second drive lever.

7. Drive arrangement as claimed in claim 6, wherein the first and second lever pivot axes are identical.

8. Drive arrangement as claimed in claim 6, wherein the first and second lever pivot axes are stationary.

9. Drive arrangement as claimed in claim 7, wherein the drive levers are arranged so as to execute opposite motions when the drive motor is actuated.

10. Drive arrangement as claimed in claim 4, wherein ends of the drive levers which face away from the respective driven lever are each equipped with an arc-shaped toothed segment which is aligned around the pivot axis of the drive levers, wherein one toothed segment has an external tooth system and the other toothed segment has an internal tooth system which faces this external tooth system, wherein the drive motor has a driving pinion which is rotatable around an axis of rotation and wherein a driving pinion of the drive motor is drivingly coupled to the toothed segments.

11. Drive arrangement as claimed in claim 4, wherein connecting joints between the first drive lever and the first driven lever and between the second drive lever and the second driven lever are guided in an arc-shaped guide rail which is aligned around a pivot axis of a pivot connection of the drive levers to each other.

12. Drive arrangement as claimed in claim 4, wherein the drive is a linear drive and ends of the drive levers which face away from the respective driven levers are coupled to the linear drive.

13. Drive arrangement as claimed in claim 4, wherein the second drive lever is eccentrically coupled to the first drive lever with respect to the pivot axis of the first drive lever and wherein the second connecting joint is guided between the second drive lever and the second driven lever in an arc-shaped guide rail.

14. Drive arrangement as claimed in claim 4, wherein an end of the first drive lever which faces away from the first driven lever is equipped with an arc-shaped toothed segment which is aligned around the pivot axis of the first drive lever, and wherein the drive motor has a driving pinion which drivingly engages the toothed segment.

15. Drive arrangement as claimed in claim 1, wherein the joint arrangement has a first joint for coupling to the first driven lever and a second joint for coupling to the second driven lever, and wherein the joints of the joint arrangement have a first and a second joint axis which are rigidly coupled to one another and are aligned perpendicular to one another.

16. Drive arrangement as claimed in claim 15, wherein the joints of the joint arrangement comprise, at least in part, a ball joint.

17. Drive arrangement as claimed in claim 4, wherein ends of the driven levers which face away from the drive levers are coupled to one another by way of a joint axis of a joint of the joint arrangement.

18. Drive arrangement as claimed in claim 4, wherein the connecting joints each have first and second joint axes which are rigidly coupled to one another and are aligned perpendicular to one another, each first joint axis being coupled to the respective driven lever and the second joint axis having a coupling to the respective drive lever.

19. Drive arrangement as claimed in claim 18, wherein the connecting joints comprise, at least in part, a ball joint.

20. Drive arrangement as claimed in claim 4, wherein at least one of the pivot axes of the drive levers is aligned essentially perpendicular to the hatch axis in the installed state.

21. Drive arrangement as claimed in claim 1, wherein the drive motor is configured for being located in an area of a rear roof frame of the body, in the installed state.

22. Drive arrangement as claimed in claim 1, wherein the joint arrangement, viewed in a transverse direction of the motor vehicle in the installed state, is configured for being located in a middle area of the vehicle near the hatch axis.

23. Hatch arrangement of a motor vehicle, comprising:
a hatch,
a motor vehicle body having a hatch opening, the hatch being pivotally coupled to the body for movement around a hatch axis for opening and closing the hatch opening, and
a drive arrangement for producing driving movement of the hatch between open and closed positions thereof, the drive arrangement having a drive with a drive motor and a transmission linkage connected to an output side of the drive motor,
wherein the transmission linkage has a first driven lever and a second driven lever for transmission of movement forces to the hatch, wherein the driven levers converge on a joint arrangement which is located on the hatch and are coupled to the joint arrangement by drive engineering, and wherein lines of dynamic effect of the two driven levers form an included angle with one another which corresponds to the respective position of the hatch.

24. Hatch arrangement as claimed in claim 23, wherein the first driven lever is pivotally coupled by way of a first connecting joint to a first drive lever and the second driven lever is pivotally coupled to a second drive lever by way of a second connecting joint, and wherein one of the two drive levers is coupled to the drive motor so as to be driven thereby.
